(19) United States
(12) Patent Application Publication
(10) Pub. No.: US 2026/0261766 A1
(43) Pub. Date: Sep. 3, 2026

(54) IMAGE PROCESSING SYSTEM AND IMAGE PROCESSING METHOD

(71) Applicant: VIA Technologies, Inc., New Taipei City (TW)

(72) Inventor: Chi-Wen Yen, New Taipei City (TW)

(73) Assignee: VIA Technologies, Inc., New Taipei City (TW)

(21) Appl. No.: 19/216,743

(22) Filed: May 23, 2025

(30) Foreign Application Priority Data
Mar. 3, 2025 (TW) 114107771

(51) Int. Cl. H04N 23/698; G06T 5/50; G06T 7/80; G07C 5/02; H04N 23/90

(52) U.S. Cl. CPC H04N 23/698; G06T 5/50; G06T 7/80; H04N 23/90; G06T 2207/20221; G06T 2207/30244; G06T 2207/30252; G07C 5/02

(57) ABSTRACT

An image processing system and an image processing method are provided. The image processing system includes a storage device and a processor. The storage device is configured to store an image blending module. The processor is coupled to the storage device and configured to execute the image blending module. The image blending module computes an angle between a vehicle front and a trailer based on a trailer wheelbase length, a yaw rate and a vehicle speed. The image blending module updates a camera extrinsic parameter based on the angle between the vehicle front and the trailer. The image blending module blends multiple captured images based on the camera extrinsic parameter to generate a panoramic image.

### CROSS-REFERENCE TO RELATED APPLICATION

This application claims the priority benefit of Taiwan application serial no. 114107771, filed on Mar. 3, 2025. The entirety of the above-mentioned patent application is hereby incorporated by reference herein and made a part of this specification.

### BACKGROUND

### Technical Field

The disclosure relates to a data processing technology, and in particular relates to an image processing system and an image processing method.

### Related Art

The panoramic image display function of a general driving assistance needs to blend multiple photographic images captured around the vehicle by multiple cameras to generate a panoramic image. However, when the vehicle is a trailer car with a vehicle front and a trailer, since the vehicle body is longer, and the rotation angles between the vehicle front and the trailer car are different, the photographic images captured by cameras disposed at different locations might not be correctly blended, leading to a condition where an image distortion is generated in the panoramic image.

### SUMMARY

The disclosure provides an image processing system and an image processing method, which can generate a good panoramic image.

The image processing system of the disclosure includes a storage device and a processor. The storage device is configured to store an image blending module. The processor is coupled to the storage device and configured to execute the image blending module. The image blending module computes an angle between a vehicle front and a trailer based on a trailer wheelbase length, a yaw rate, and a vehicle speed. The image blending module updates a camera extrinsic parameter based on the angle between the vehicle front and the trailer. The image blending module blends multiple captured images based on the camera extrinsic parameter to generate a panoramic image.

The image processing method of the disclosure includes the following steps: an angle between a vehicle front and a trailer is computed based on a trailer wheelbase length, a yaw rate, and a vehicle speed; a camera extrinsic parameter is updated based on the angle between the vehicle front and the trailer; and multiple captured images are blended based on the camera extrinsic parameter to generate a panoramic image.

Based on the above, the image processing system and the image processing method of the disclosure can dynamically update the camera extrinsic parameter based on a real-time yaw rate to effectively generate a precise panoramic image.

In order to make the features and advantages of the disclosure more comprehensible, the following examples are given and described in detail with the accompanying drawings as follows.

### BRIEF DESCRIPTION OF THE DRAWINGS

FIG. 1 is a schematic view of an image processing system according to an embodiment of the disclosure.

FIG. 2 is a schematic top view of a vehicle front and a trailer according to an embodiment of the disclosure.

FIG. 3 is a schematic side view of a vehicle front and a trailer according to an embodiment of the disclosure.

FIG. 4 is a flow chart of an image processing method according to an embodiment of the disclosure.

FIG. 5 is a schematic steering view of a vehicle front and a trailer according to an embodiment of the disclosure.

### DESCRIPTION OF THE EMBODIMENTS

In order to make the content of the disclosure more comprehensible, embodiments in which the disclosure may be implemented are listed as follows. In addition, wherever possible, elements/components/steps with the same reference numerals in the drawings and embodiments represent the same or similar components.

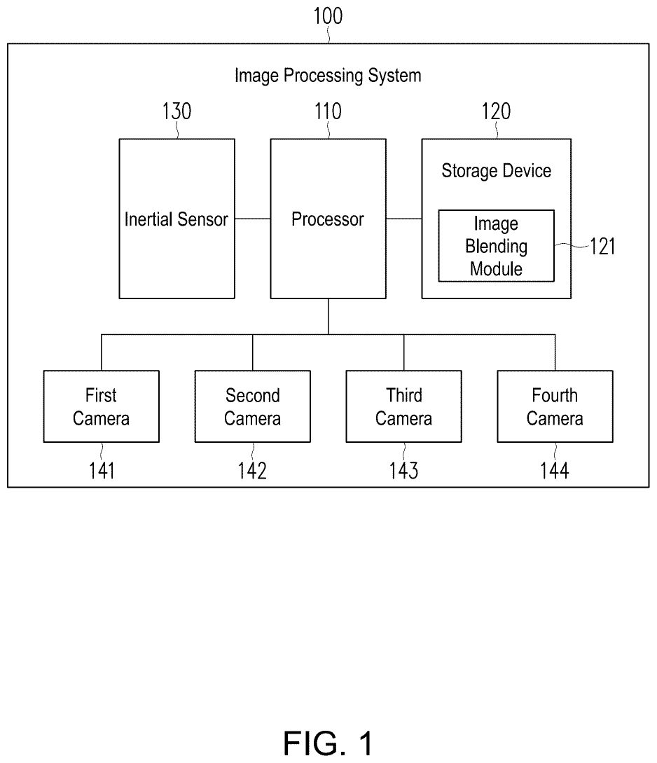

FIG. 1 is a schematic view of an image processing system according to an embodiment of the disclosure. Referring to FIG. 1, an image processing system 100 includes a processor 110, a storage device 120, an inertial sensor 130, a first camera 141, a second camera 142, a third camera 143, and a fourth camera 144. The processor 110 is coupled to the storage device 120, the inertial sensor 130, the first camera 141, the second camera 142, the third camera 143, and the fourth camera 144. In the embodiment, the inertial sensor 130 is configured to output a yaw rate to the processor 110.

In the embodiment, the image processing system 100 may be disposed on a trailer vehicle having a vehicle front and a trailer, and may be, for example, an Advanced Driver Assistance Systems (ADAS) or a dashcam. In an embodiment, the image processing system 100 may also not include the inertial sensor 130, the first camera 141, the second camera 142, the third camera 143, and the fourth camera 144. The processor 110 and the storage device 120 are integrated into one equipment. In the embodiment, the first camera 141, the second camera 142, the third camera 143, and the fourth camera 144 may capture respectively toward different directions to obtain multiple captured images and provide to the processor 110. In other embodiments, the number of cameras may also be at least two. The cameras may capture toward at least two different directions.

In the embodiment, the processor 110 may be, for example, a central processing unit (CPU), or other programmable general-purpose or special-purpose microprocessor, digital signal processor (DSP), image processing unit (IPU), graphics processing unit (GPU), programmable controller, application specific integrated circuits (ASIC), programmable logic device (PLD), other similar processing device or a combination of the devices.

In the embodiment, the storage device 120 may be, for example, a dynamic random access memory (DRAM), flash memory, or non-volatile random access memory (NVRAM), etc. In the embodiment, the storage device 120 may store an image blending module 121. The processor 110 may read and execute the image blending module 121. In the process of executing the image blending module 121, locations of all cameras in the world coordinates may be obtained, and a captured image of each camera may be mapped to the world coordinates to be fused into a blended image. An extrinsic parameter matrix of the camera is composed of a rotation matrix (R) and a translation vector (T) that are needed when converting from camera coordinates to world coordinates, allowing the image blending module 121 to understand to which location each pixel of the captured image should be mapped.

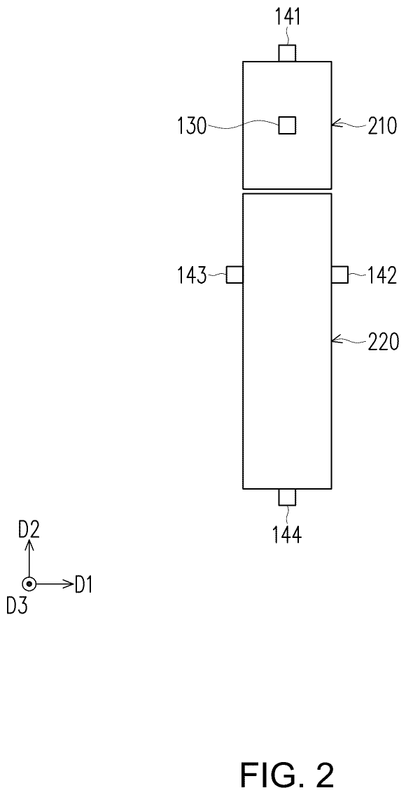

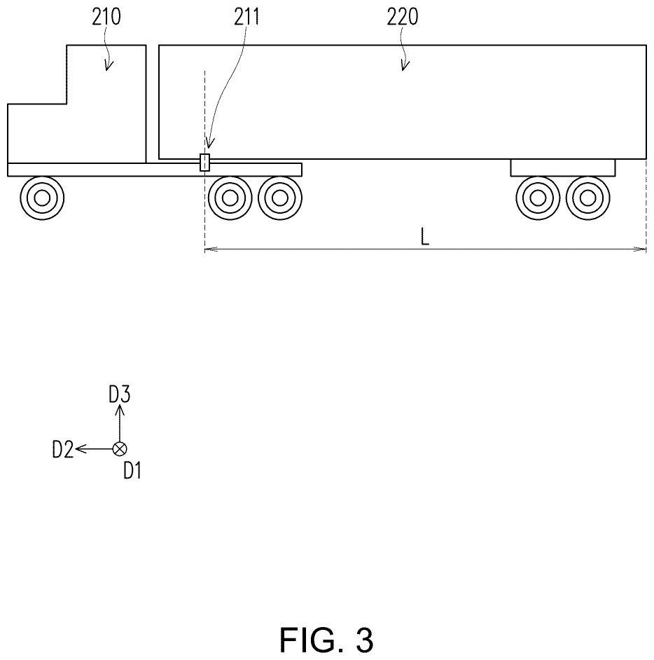

FIG. 2 is a schematic top view of a vehicle front and a trailer according to an embodiment of the disclosure. FIG. 3 is a schematic side view of a vehicle front and a trailer according to an embodiment of the disclosure. Referring to FIG. 1 and FIG. 2 first, a direction D1 and a direction D2 are two directions on a horizontal plane, and a direction D3 is a vertical direction. The directions D1 to D3 are perpendicular to each other. In the embodiment, the image processing system 100 may be mounted on a vehicle front 210 and a trailer 220. A facing direction when there is no relative rotation between the vehicle front 210 and the trailer 220 is defined as D2. In the embodiment, the inertial sensor 130 may be disposed on the vehicle front 210. The first camera 141 may be disposed on the vehicle front 210, and record toward the direction D2 (that is, in front of the vehicle front). The second camera 142 may be disposed on a right side of the trailer 220, and record toward the direction D1 (that is, right of the trailer). The third camera 143 may be disposed on a left side of the trailer 220, and record toward a direction opposite to the direction D1 (that is, left of the trailer). The fourth camera 144 may be disposed on a back side of the trailer 220, and record toward a direction opposite to the direction D2 (that is, behind the trailer). Next, please refer to FIG. 3. In the embodiment, the trailer 220 may be engaged with the vehicle front 210 through a connecting member 221. A distance from the connecting member 211 to the end of the trailer 220 is a trailer wheelbase length L. In other embodiments, the second camera 142 and/or the third camera 143 may also be disposed on the left and/or right sides of the vehicle front 210.

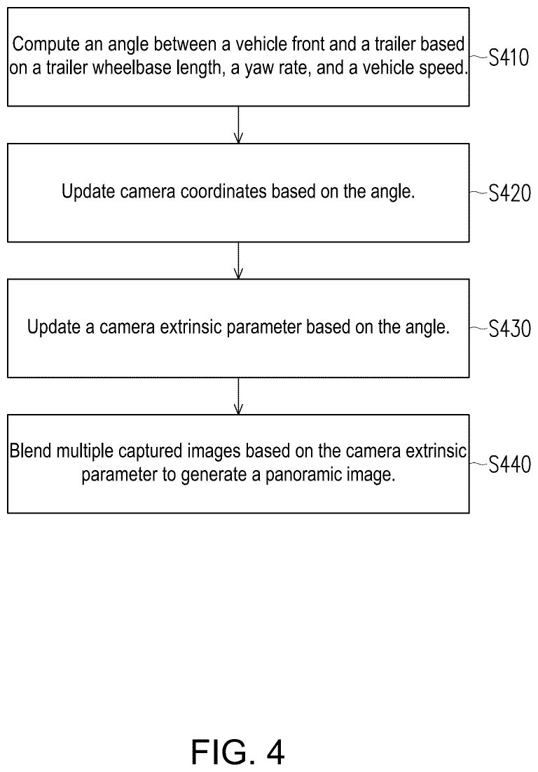

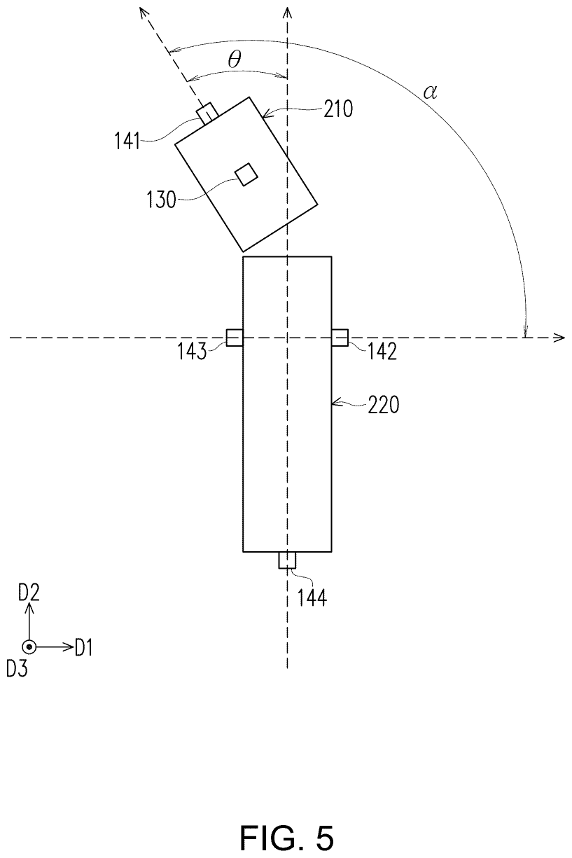

FIG. 4 is a flow chart of an image processing method according to an embodiment of the disclosure FIG. 5 is a schematic steering view of a vehicle front and a trailer according to an embodiment of the disclosure. Referring to FIG. 1 to FIG. 5, the image processing system 100 may execute the image blending module 121 to perform the following steps S410 to S440. In step S410, the image blending module 121 computes an angle between the vehicle front 210 and the trailer 220 based on the trailer wheelbase length L, a yaw rate, and a vehicle speed. It is worth noting that the angle is an angle between a longitudinal axis of the vehicle front 210 and a longitudinal axis of the trailer 220. In the embodiment, the processor 110 may obtain the yaw rate from the inertial sensor 130. In addition, the image processing system 100 may further include equipment such as a dashcam or a speed detector to obtain the vehicle speed.

In the embodiment, the image blending module 121 computes an angle between the vehicle front 210 and the trailer 220 at a next time point based on the trailer wheelbase length, a yaw rate at a current time point, and a vehicle speed at the current time point. Specifically, the image blending module 121 executes the following Formula (1) to Formula (3) to compute the angle between the vehicle front 210 and the trailer 220. In the following Formula (1) to Formula (3), Φ(t) is a vehicle front heading angle (at the current time point). yaw(t) is the yaw rate (at the current time point). Ψ(t) is a trailer heading angle. v(t) is the vehicle speed. L is the trailer wheelbase length. t is a timestamp of the inertial sensor at the current time point, t+Δt is a timestamp of the next time point, and Δt is the time difference between the current time point and the next time point, and is determined by an update rate of the inertial sensor 130. θ(t+Δt) is the angle between the vehicle front 210 and the trailer 220 (at the next time point).

$$Φ ( t + Δ t ) = Φ ( t ) + Δ t \times yaw ( t ) \qquad Formula ( 1 )$$

$$Ψ ( t + Δ t ) = Ψ ( t ) - Δ t \times \frac{v ( t )}{L} \times sin ( Ψ ( t ) - Φ ( t + Δ t ) ) \qquad Formula ( 2 )$$

$$θ ( t + Δ t ) = Ψ ( t + Δ t ) - Φ ( t + Δ t ) \qquad Formula ( 3 )$$

In the embodiment, the image blending module 121 computes the angle between the vehicle front 210 and the trailer 220 by taking the vehicle front heading angle Φ(t) and the trailer heading angle Ψ(t) at the start (t=0) as 0. In an embodiment, it is assumed that a sampling frequency of the inertial sensor 130 is 50 Hz, so Δt is 20 milliseconds (ms). In other embodiments, Δt may also be determined based on other factors (such as the computing speed of the processor 110 or the frame rate of the camera).

In step S420, the image blending module 121 updates camera coordinates based on the angle θ(t+Δt). In the embodiment, the image blending module 121 executes the following Formula (4) and Formula (5) to update the camera coordinates. In the following Formula (4) and Formula (5), camera coordinates of the first camera 141 at the current time point are (x(t), y(t), z0). Camera coordinates of the first camera 141 at the next time point are (x(t+Δt),y(t+Δt),z0), where x(t) and y(t) are respectively two coordinates on the horizontal plane, and z0 is a height of the first camera (that is, the vertical coordinate). The height of the camera may not change due to the rotation of the vehicle on the horizontal plane, so z0 is a fixed value here.

$$x ( t + Δ t ) = x ( t ) \times cos ( θ ( t + Δ t ) ) - y ( t ) \times sin ( θ ( t + Δ t ) ) \qquad Formula ( 4 )$$

$$y ( t + Δ t ) = x ( t ) \times sin ( θ ( t + Δ t ) ) + y ( t ) \times cos ( θ ( t + Δ t ) ) \qquad Formula ( 5 )$$

In step S430, the image blending module 121 may update camera extrinsic parameters based on the angle θ(t+Δt) between the vehicle front 210 and the trailer 220. In the embodiment, the image blending module 121 may execute the following Formula (6) and Formula (7) to update the camera extrinsic parameters. In the following Formula (6) and Formula (7), Mₑₓₜ is a camera extrinsic parameter matrix. R_{z}(α), R_{y}(β), Rₓ(γ) are respectively the rotation matrices of three axes. α, β, γ are respectively the rotation angles of the three axes. The translation vector T is the updated camera coordinates (x(t+Δt),y(t+Δt),z0). The image blending module 121 may update a rotation angle α (that is, the yaw angle) based on the angle θ(t+Δt).

$${M}_{ext} = [ R \vert T ] \qquad Formula ( 6 )$$

$$R = {R}_{z} ( α ) \times {R}_{y} ( β ) \times {R}_{x} ( γ ) = [ \begin{matrix}cos α & - sin α & 0 \\ sin α & cos α & 0 \\ 0 & 0 & 1\end{matrix} ] [ \begin{matrix}cos β & 0 & sin β \\ 0 & 1 & 0 \\ - sin β & 0 & cos β\end{matrix} ] [ \begin{matrix}1 & 0 & 0 \\ 0 & cos γ & - sin β \\ 0 & sin β & cos γ\end{matrix} ] \qquad Formula ( 7 )$$

In the foregoing computation, only the rotation angle α around the Z axis (that is, the rotation around the vertical direction on the horizontal plane) and a rotation matrix R_{z}(α) need to be updated. Assuming that an initial rotation angle of the first camera 141 relative to the second camera 142 is 90 degrees (as shown in FIG. 2), the rotation angle α configured to update the rotation matrix R_{z}(α) is equal to 90 plus the angle θ(t+Δt) at the next time point (as shown in FIG. 5). For instance, if the angle θ(t+Δt) at the next time point is 15 degrees, the rotation angle α may be 105 degrees (=90+15). Therefore, the image blending module 121 may update the rotation matrix R_{z}(α) and may effectively update the camera extrinsic parameter matrix Mₑₓₜ.

In step S440, the image blending module 121 blends multiple captured images based on the camera extrinsic parameter matrix Mₑₓₜ to generate a panoramic image. In the embodiment, the image blending module 121 may perform the foregoing computation to obtain the camera extrinsic parameters needed for blending the first captured image obtained by the first camera 141 and the second captured image obtained by the second camera 142. Furthermore, the camera extrinsic parameters needed for blending the first image captured by the first camera 141 and the third image captured by the third camera 143 may be obtained by analogy. Therefore, the image blending module 121 may effectively draw a correct panoramic image. In the embodiment, the second camera 142, the third camera 143 and the fourth camera 144 are disposed on the trailer 220. Only the first camera 141 disposed on the vehicle front 210 rotates relative to the trailer 220, so only the camera extrinsic parameters of the first camera 141 are updated. In other embodiments, if there are more cameras disposed on the vehicle front 210, those skilled in the art may also update the corresponding camera extrinsic parameters according to the technical means in the foregoing embodiment in conjunction with appropriate logical deduction. Alternatively, the camera disposed on the trailer 220 may be regarded as rotating relative to the vehicle front 210 and the camera extrinsic parameters of the camera disposed on the trailer 220 may be updated, which will not be elaborated here.

In summary, the image processing system and image processing method of the disclosure may effectively dynamically correct the camera extrinsic parameters configured to blend a captured result of the camera disposed on the vehicle front with a captured result of the camera disposed on the left and right sides of the trailer through only one inertial sensor that provides a yaw rate in real time, so that a correct panoramic image can be effectively drawn. In addition, the computation amount of the processor needed for correcting the camera extrinsic parameters in the disclosure is quite small, which may not cause burden on the processor or the memory of a driving assistance system or a dashcam.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An image processing system, comprising:
a storage device, configured to store an image blending module; and
a processor, coupled to the storage device, and configured to execute the image blending module,
wherein the image blending module computes an angle between a vehicle front and a trailer based on a trailer wheelbase length, a yaw rate and a vehicle speed,
wherein the image blending module updates a camera extrinsic parameter based on the angle between the vehicle front and the trailer, and the image blending module blends a plurality of captured images based on the camera extrinsic parameter to generate a panoramic image.

2. The image processing system according to claim 1, further comprising:
an inertial sensor, coupled to the processor, and disposed on the vehicle front,
wherein the inertial sensor is configured to output the yaw rate to the processor.

3. The image processing system according to claim 1, further comprising:
a first camera, disposed on the vehicle front, coupled to the processor, and recording toward a first direction to generate a first captured image; and
a second camera, disposed on the trailer, coupled to the processor, and recording toward a second direction to generate a second captured image,
wherein the image blending module blends the first captured image and the second captured image based on the camera extrinsic parameter to generate the panoramic image.

4. The image processing system according to claim 3, wherein the image blending module computes an angle between the vehicle front and the trailer at a next time point based on the trailer wheelbase length, a yaw rate at a current time point and a vehicle speed at the current time point.

5. The image processing system according to claim 4, wherein the image blending module executes the following Formula (1) to Formula (3) to compute the angle between the vehicle front and the trailer,
$$Φ ( t + Δ t ) = Φ ( t ) + Δ t \times yaw ( t ) \qquad Formula ( 1 )$$
$$Ψ ( t + Δ t ) = Ψ ( t ) - Δ t \times \frac{v ( t )}{L} \times sin ( Ψ ( t ) - Φ ( t + Δ t ) ) \qquad Formula ( 2 )$$
$$θ ( t + Δ t ) = Ψ ( t + Δ t ) - Φ ( t + Δ t ) \qquad Formula ( 3 )$$
wherein Φ(t) is a vehicle front heading angle, yaw(t) is the yaw rate, Ψ(t) is a trailer heading angle, v (t) is the vehicle speed, L is the trailer wheelbase length, t is a timestamp at the current time point, t+Δt is a timestamp at the next time point, and θ(t+Δt) is the angle between the vehicle front and the trailer.

6. The image processing system according to claim 4, wherein the image blending module updates camera coordinates based on the angle between the vehicle front and the trailer.

7. The image processing system according to claim 6, wherein the image blending module executes the following Formula (4) and Formula (5) to update the camera coordinates,
$$x ( t + Δ t ) = x ( t ) \times cos ( θ ( t + Δ t ) ) - y ( t ) \times sin ( θ ( t + Δ t ) ) \qquad Formula ( 4 )$$
$$y ( t + Δ t ) = x ( t ) \times sin ( θ ( t + Δ t ) ) + y ( t ) \times cos ( θ ( t + Δ t ) ) \qquad Formula ( 5 )$$
wherein θ(t+Δt) is the angle between the vehicle front and the trailer, camera coordinates of the first camera at the current time point are (x(t),y(t),z0), and camera coordinates of the first camera at the next time point are (x(t+Δt),y(t+Δt),z0), wherein z0 is a height of the first camera.

8. The image processing system according to claim 6, wherein the image blending module updates a rotation matrix in the camera extrinsic parameter based on the angle between the vehicle front and the trailer, and the image blending module updates a translation vector in the camera extrinsic parameter based on the camera coordinates.

9. An image processing method, comprising:
computing an angle between a vehicle front and a trailer based on a trailer wheelbase length, a yaw rate and a vehicle speed;
updating a camera extrinsic parameter based on the angle between the vehicle front and the trailer; and
blending a plurality of captured images based on the camera extrinsic parameter to generate a panoramic image.

10. The image processing method according to claim 9, further comprising:
generating the yaw rate through an inertial sensor.

11. The image processing method according to claim 9, further comprising:
recording toward a first direction through a first camera to generate a first captured image; and
recording toward a second direction through a second camera to generate a second captured image,
wherein the panoramic image is generated by blending the first captured image and the second captured image based on the camera extrinsic parameter.

12. The image processing method according to claim 11, wherein steps of computing the angle between the vehicle front and the trailer comprise computing an angle between the vehicle front and the trailer at a next time point based on to the trailer wheelbase length, a yaw rate at a current time point and a vehicle speed at the current time point.

13. The image processing method according to claim 12, wherein the steps of computing the angle between the vehicle front and the trailer comprise:
executing the following Formula (1) to Formula (3),
$$Φ ( t + Δ t ) = Φ ( t ) + Δ t \times yaw ( t ) \qquad Formula ( 1 )$$
$$Ψ ( t + Δ t ) = Ψ ( t ) - Δ t \times \frac{v ( t )}{L} \times sin ( Ψ ( t ) - Φ ( t + Δ t ) ) \qquad Formula ( 2 )$$
$$θ ( t + Δ t ) = Ψ ( t + Δ t ) - Φ ( t + Δ t ) \qquad Formula ( 3 )$$
wherein Φ(t) is a vehicle front heading angle, yaw(t) is the yaw rate, Ψ(t) is a trailer heading angle, v(t) is the vehicle speed, L is the trailer wheelbase length, t is a timestamp at the current time point, t+Δt is a timestamp at the next time point, and θ(t+Δt) is the angle between the vehicle front and the trailer.

14. The image processing method according to claim 12, further comprising:
updating camera coordinates based on the angle between the vehicle front and the trailer.

15. The image processing method according to claim 14, wherein steps of updating the camera coordinates comprise:
executing the following Formula (4) and Formula (5),
$$x ( t + Δ t ) = x ( t ) \times cos ( θ ( t + Δ t ) ) - y ( t ) \times sin ( θ ( t + Δ t ) ) \qquad Formula ( 4 )$$
$$y ( t + Δ t ) = x ( t ) \times sin ( θ ( t + Δ t ) ) + y ( t ) \times cos ( θ ( t + Δ t ) ) \qquad Formula ( 5 )$$
wherein θ(t+Δt) is the angle between the vehicle front and the trailer, camera coordinates of the first camera at the current time point are (x(t),y(t),z0), and camera coordinates of the first camera at the next time point are (x(t+Δt),y(t+Δt),z0), wherein z0 is a height of the first camera.

16. The image processing method according to claim 14, wherein steps of updating the camera extrinsic parameter comprise:
updating a rotation matrix in the camera extrinsic parameter based on the angle between the vehicle front and the trailer, and updating a translation vector in the camera extrinsic parameter based on the camera coordinates.
